(19) United States
(12) Patent Application Publication
(10) Pub. No.: US 2017/0329177 A1
(43) Pub. Date: Nov. 16, 2017

(54) Liquid Crystal Display Panel, Liquid Crystal Display Apparatus, and Method of Manufacturing Liquid Crystal Display Panel

(71) Applicant: Sakai Display Products Corporation, Sakai-shi, Osaka (JP)

(72) Inventor: Hidetoshi Nakagawa, Sakai-shi, Osaka (JP)

(21) Appl. No.: 15/526,994

(22) PCT Filed: Nov. 28, 2014
(86) PCT No.: PCT/JP2014/081572

§ 371 Date: May 15, 2017

(51) Int. Cl. G02F 1/1335

(52) U.S. Cl. CPC G02F 1/133516; G02F 2201/40

(57) ABSTRACT

The liquid crystal display panel includes two opposing substrates provided with liquid crystal sealed therebetween. On one substrate a plurality of colored parts are arranged so as to constitute one pixel, and a plurality of boundary regions are arranged between a plurality of adjacent colored parts and around the plurality of colored parts. The boundary region arranged between adjacent colored parts has a width smaller than that of the boundary region arranged around the plurality of colored parts.

### CROSS-REFERENCE TO RELATED APPLICATIONS

This application is the national phase under 35 U. S. C. §371 of PCT International Application No. PCT/JP2014/081572 which has an International filing date of Nov. 28, 2014 and designated the United States of America.

### FIELD

The present invention relates to a liquid crystal display panel, a liquid crystal display apparatus comprising the liquid crystal display panel, and a method of manufacturing the liquid crystal display panel.

### BACKGROUND

In recent years, a liquid crystal display panel employed in many display apparatuses has a configuration in which a pair of substrates are opposed with a predetermined interval, and liquid crystal is filled therebetween. On one substrate, a picture element electrode for applying a voltage to the liquid crystal, a switching element such as a thin film transistor for driving the picture element electrode, various wirings such as a gate bus line and a source bus line, an alignment film for applying a pretilt angle to the liquid crystal, and the like, are formed in a laminated shape. In addition, on the other substrate, a black matrix, a color filter layer of a predetermined color, a counter electrode, an alignment film, and the like, are formed in a similarly laminated shape.

The black matrix and the color filter layer are formed by using a photolithographic method. For example, the black matrix is formed through a process of applying a black photoresist material to a surface of the substrate, an exposure process of irradiating a predetermined pattern region of the photoresist material with a light energy through a photo mask, and a process of removing an unnecessary portion of the photoresist material (a portion which is not irradiated with the light energy).

In forming the black matrix as described above, the photo mask is used. Since an accuracy of the formed black matrix depends on an accuracy of the photo mask, a high processing accuracy is required for the photo mask. Meanwhile, in recent years, with an increase in size of the substrate, a size of the photo mask also increases, and a size of an exposure device needs to be increased, thereby causing an increase in manufacturing cost.

To cope with such a situation, instead of exposing the entire substrate at one time in the exposure process, a divided exposure method of dividing the substrate into several regions to expose the substrate is employed. In the divided exposure method, there is a need to splice patterns of adjacent regions with each other. Therefore, the exposure is performed on the adjacent portions twice to splice the patterns. However, if the patterns are spliced in a well-defined rectangle shape, splicing unevenness is seen. Thereby, a method of providing a certain degree of width to the splicing part, and splicing the patterns in a mosaic pattern is generally used. The mosaic pattern is a pattern in which a density of presence or absence of the pattern is changed, and means a pattern which is set so as to change the density of the pattern from dense to coarse as it is separated from its own exposure pattern. However, if the pattern is too thick in order to change the density, an effect of the mosaic pattern is diminished, and then the splicing part is divided within one picture element (Japanese Patent Laid-open Publication No. 2000-66235). Be noted that the picture element means a single-color portion constituting one pixel. Generally, three picture elements of red, green and blue constitute one pixel.

In addition, the photo mask is positionally shifted in directions opposite to each other during the first and second exposures, and thereby it is necessary to thicken the pattern so as to prevent a slit (gap) from being generated in the formed pattern.

Further, in forming the color filter, it is also necessary to consider the positional shift when coloring the picture element after forming the black matrix. The reason is that, a gap is formed between a colored portion and the black matrix, such that a problem of a so-called void in which light is leaked therefrom occurs. From the viewpoint of preventing the void, it is necessary to thicken the black matrix.

### SUMMARY

As described above, in the conventional art, since the pattern of the splicing part is thickened, there is a problem of a reduction in aperture ratio. In recent years, a definition of the liquid crystal display panel is increased and a size of one pixel thereof is decreased. That is, the number of pixels included in one liquid crystal display panel is increased, and as a result, there is a problem that an area occupied by the black matrix is also increased, and thereby the aperture ratio is reduced.

In consideration of the above-mentioned circumstances, it is an object of the present disclosure to provide a liquid crystal display panel, and the like that suppresses a reduction in aperture ratio even in a liquid crystal display panel having high definition.

The liquid crystal display panel according to the present disclosure is a liquid crystal display panel comprising two opposing substrates provided with liquid crystal sealed therebetween, wherein on one substrate a plurality of colored parts are arranged so as to constitute one pixel, and a plurality of boundary regions are arranged between a plurality of adjacent colored parts and around the plurality of colored parts, and wherein the boundary region arranged between adjacent colored parts has a width smaller than that of the boundary region arranged around the plurality of colored parts.

According to the present disclosure, the boundary region arranged between adjacent colored parts has a width smaller than that of the boundary region arranged around the plurality of colored parts. That is, since the boundary region in the portion on which the screen splicing is not performed is thinner than the boundary region on which the screen splicing is performed, it is possible to suppress a reduction in aperture ratio even in a liquid crystal display panel having high definition.

The liquid crystal display panel according to the present disclosure is characterized in that a plurality of the boundary regions arranged around the plurality of colored parts are arranged at a constant interval.

According to the present disclosure, the plurality of boundary regions arranged around the plurality of colored parts are arranged at a constant interval. That is, since the boundary regions on which the screen splicing is performed are arranged at a constant interval, it is possible to suppress a reduction in aperture ratio even in a liquid crystal display panel having high definition.

The liquid crystal display panel according to the present disclosure is characterized in that the plurality of the boundary regions arranged around the plurality of colored parts are arranged between adjacent pixels.

According to the present disclosure, the plurality of the boundary regions arranged around the plurality of colored parts are arranged between the adjacent pixels. That is, by constituting a mask pattern in a pixel unit, the mask pattern can be used for manufacturing a plurality of liquid crystal display panels having different numbers of pixels from each other.

The liquid crystal display apparatus according to the present disclosure is a liquid crystal display apparatus comprising the above-described liquid crystal display panel as a display section.

According to the present disclosure, it is possible to achieve a display apparatus comprising a liquid crystal display panel having high definition while suppressing a reduction in aperture ratio.

The method of manufacturing a liquid crystal display panel according to the present disclosure is a method of manufacturing a liquid crystal display panel, comprising: preparing a photo mask provided with linear patterns at positions corresponding to boundary regions between a plurality of adjacent colored parts and around the plurality of colored parts, the liner pattern in a portion corresponding to the boundary region between adjacent colored parts having a width smaller than that of the liner pattern in a portion corresponding to the boundary region around the plurality of colored parts; sequentially performing exposure on one substrate by photolithography using the photo mask so that the colored parts are arranged in a matrix to form lattice-shaped boundary regions; adding colors inside lattices formed by the boundary regions to form a plurality of colored parts so as to constitute respective pixels each including a plurality of colored parts; and opposing the one substrate and the other substrate, and then sealing liquid crystal therebetween.

According to the present disclosure, since boundary regions (black matrix) are formed by using the photo mask in which the liner pattern in a portion corresponding to the boundary region between adjacent colored parts has the width smaller than that of the liner pattern in a portion corresponding to the boundary region around a plurality of colored parts, it is possible to manufacture a liquid crystal display panel having high definition while suppressing a reduction in aperture ratio.

The method of manufacturing a liquid crystal display panel according to the present disclosure is a method of manufacturing a liquid crystal display panel, comprising: preparing a photo mask provided with linear patterns at positions corresponding to boundary regions between a plurality of adjacent colored parts and around the plurality of colored parts, the liner pattern in a portion corresponding to the boundary region between adjacent colored parts having a width smaller than that of the liner pattern in a portion corresponding to the boundary region around the plurality of colored parts, the photo mask being capable of simultaneously forming boundary regions corresponding to a plurality of pixels each including a plurality of colored parts; sequentially performing exposure on one substrate by photolithography using the photo mask so that the pixels are arranged in a matrix to form lattice-shaped boundary regions; adding colors inside lattices formed by the boundary regions to form a plurality of colored parts so as to constitute respective pixels; and opposing the one substrate and the other substrate, and then sealing liquid crystal therebetween.

According to the present disclosure, since the photo mask capable of simultaneously forming boundary regions corresponding to a plurality of pixels is used, it is possible to reduce the number of times of exposure for forming the boundary regions (black matrix).

In the present disclosure, it is possible to secure an aperture ratio in a liquid crystal display panel having high definition.

The above and further objects and features will more fully be apparent from the following detailed description with accompanying drawings.

### BRIEF DESCRIPTION OF THE DRAWINGS

FIG. 1 is a cross-sectional view illustrating a major part of a liquid crystal display apparatus.

FIG. 2 is a flowchart illustrating an example of a process of forming a black matrix.

FIGS. 3A to 3C are explanatory views illustrating an example of the process of forming the black matrix by drawings.

FIG. 4 is an explanatory view illustrating an example of a mask pattern of a photo mask.

FIG. 5 is an explanatory view illustrating an example of a color filter layer.

FIG. 6 is a cross-sectional view illustrating an example of the color filter layer.

FIG. 7 is an explanatory view illustrating an example of the mask pattern of the photo mask.

FIG. 8 is an explanatory view illustrating an example of the mask pattern of the photo mask.

FIG. 9 is an explanatory view illustrating an example of the mask pattern of the photo mask.

FIG. 10 is an explanatory view illustrating an example of a color filter layer.

FIG. 11 is a cross-sectional view illustrating an example of the color filter layer.

FIG. 12 is an explanatory view illustrating an example of the mask pattern of the photo mask.

FIG. 13 is an explanatory view illustrating an example of the mask pattern of the photo mask.

### DETAILED DESCRIPTION

Hereinafter, the present invention will be described in detail with reference to the accompanying drawings illustrating embodiments thereof.

### Embodiment 1

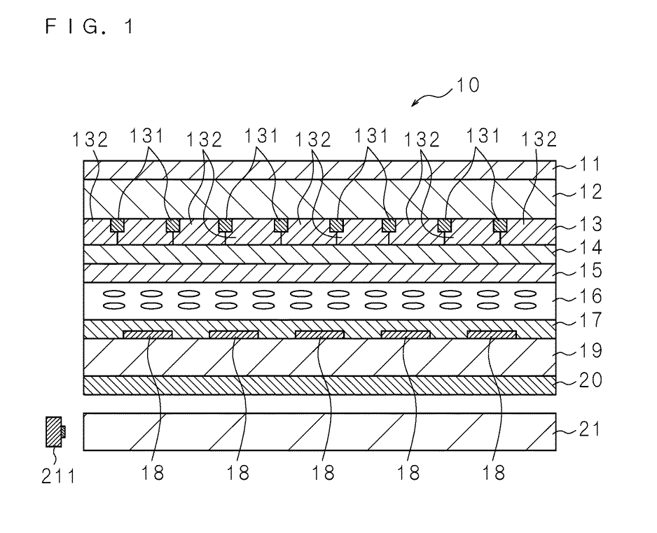

FIG. 1 is a cross-sectional view illustrating a major part of a liquid crystal display apparatus 10. An upper side of FIG. 1 is a side facing a viewer. The liquid crystal display apparatus 10 comprises a polarizing plate 11, a transparent substrate 12, a color filter layer 13, a transparent electrode 14, an alignment film 15, a liquid crystal layer 16, an alignment film 17, a transparent electrode 18, a transparent substrate 19, a polarizing plate 20 and a backlight 21, which are laminated thereon in an order from the side facing the viewer.

The polarizing plates 11 and 20 are adapted to polarize light incident thereon or emitted therefrom in a specific direction. Light passing through the polarizing plate 11 and light passing through the polarizing plate 20 have different polarization directions by 90 degrees. The transparent substrate 12 is, for example, a rectangular plate made of glass. The color filter layer 13 includes a black matrix 131 (boundary region) and a color filter 132 (colored part). The color filter layer 13 is formed on the transparent substrate 12. The transparent electrodes 14 and 18 and the alignment films 15 and 17 control an alignment of liquid crystal contained in the liquid crystal layer 16. The transparent substrate 19 is formed of: inorganic glass such as quartz glass, borosilicate glass, soda glass; a substrate made of plastic such as polyethylene terephthalate (PET), polyethersulfone (PES), polycarbonate (PC); an inorganic thin film such as silicon oxide, aluminum oxide, silicon nitride, silicon oxynitride formed on a surface of the glass or the plastic substrate or the like. The backlight 21 converts light from a light source 211 such as a light emitting diode (LED) into planar light and irradiates the polarizing plate 20 with the planar light. The remaining portion of the liquid crystal display apparatus 10 except for the backlight 21 (including the light source 211) is referred to as a liquid crystal display panel.

Next, a process of forming a black matrix will be described. In forming the black matrix, a screen splicing exposure method is employed. The screen splicing exposure method is a method in which a pattern required to form a black matrix in one transparent substrate is divided into two or more divided patterns, and the divided patterns are formed on photo masks, and these divided patterns are transferred to adjacent regions on the transparent substrate to couple images of the divided patterns with each other (screen splicing) on the transparent substrate, such that a transparent substrate having a large area can be formed even in an exposure device with a small exposure field or image field.

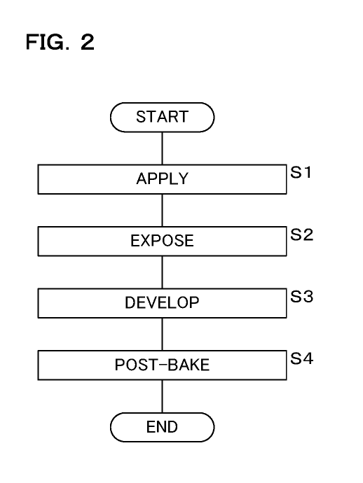

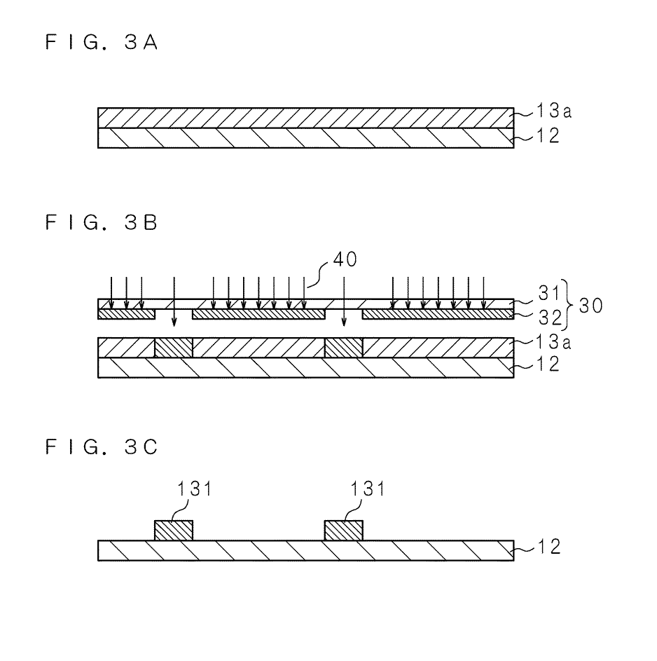

FIG. 2 is a flowchart illustrating an example of a process of forming a black matrix. FIGS. 3A to 3C are explanatory views illustrating an example of the process of forming the black matrix by drawings. A precleaned transparent substrate 12 is prepared, and a black photosensitive resin composition 13a is applied to one surface thereof (step S1, FIG. 3A). The black photosensitive resin composition 13a is obtained by dispersing metal oxide or pigment such as carbon black, titanium oxide, titanium oxynitride, iron tetroxide, or other light shielding material in a photosensitive resin. The black photosensitive resin composition 13a is exposed through a photo mask 30 (step S2, FIG. 3B). The black photosensitive resin composition 13a is developed (step S3). Post-baking is performed thereon to remove a cleaning solution (step S4, FIG. 3C).

In manufacturing the liquid crystal display panel, the transparent substrate 12 on which the color filters 132 are formed and the transparent substrate 19 are bonded so as to face each other. After the transparent substrate 12 and the transparent substrate 19 are bonded to each other, liquid crystal is injected and sealed therebetween. Further, the polarizing plates 11 and 20 are attached to the transparent substrates 12 and 19, respectively, and assembly of the liquid crystal display panel is completed. Then, the separately assembled backlight 21 is combined with the liquid crystal display panel, thereby completing the liquid crystal display apparatus 10.

Subsequently, the photo mask 30 used in an exposure process will be described. The photo mask 30 includes a photo mask substrate 31 and a light shielding film 32. The photo mask substrate 31 is a substrate which is made of, for example, synthetic quartz, soda-lime glass, alkali-free glass, or the like, and is transparent with respect to exposure light. The light shielding film 32 shields the exposure light during the exposure process. The light shielding film 32 is formed on the photo mask substrate 31 by, for example, a chromium (Cr)-based material. The light shielding film 32 is, for example, a CrN film, a CrC film, a CrCO film, a CrO film, a CrON film, or a laminated film thereof.

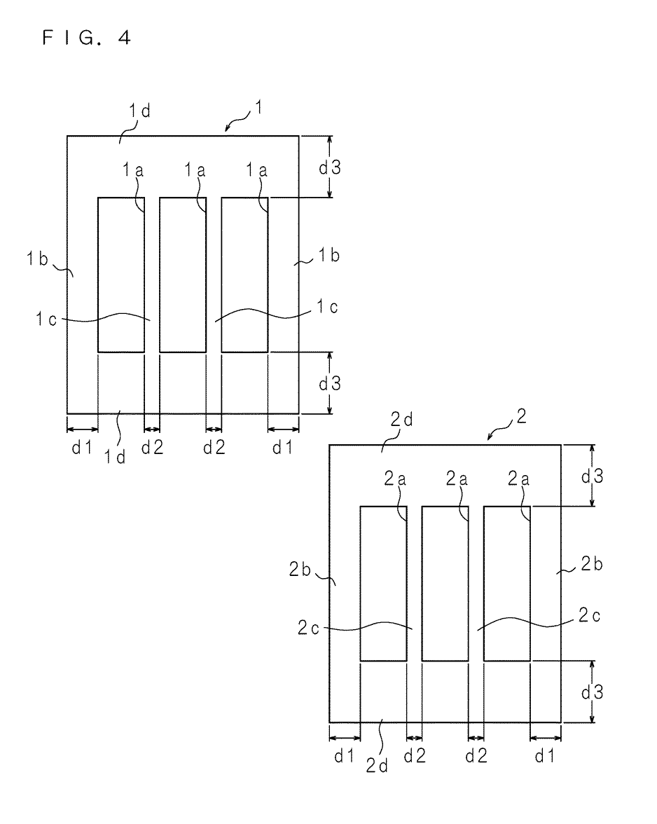

FIG. 4 is an explanatory view illustrating an example of the mask pattern of the photo mask 30. In Embodiment 1, as the photo mask 30, two types of one having a first mask pattern 1 and one having a second mask pattern 2 are used. The photo mask 30 having the first mask pattern 1 is used for a first exposure and the photo mask 30 having the second mask pattern 2 is used for a second exposure. Since the second mask pattern 2 is the same as the first mask pattern 1, therefore, in the following description, portions corresponding to the first mask pattern will be denoted by corresponding reference numerals, and will be collectively described.

The first mask pattern 1 (second mask pattern 2) is formed in a rectangular shape, and three identical rectangular window parts 1a (2a) are formed side by side in a lateral direction in the first mask pattern 1 (second mask pattern 2). The window parts 1a (2a) are portions where color layers are formed. In the first mask pattern 1 (2), it is possible to form a black matrix for three picture elements (RGB), that is, for one pixel. Each picture element has a size in a longitudinal direction longer than a size in the lateral direction. As illustrated in FIG. 4, a width d2 of a mask 1c (2c) at a boundary portion of the window parts 1a (2a) in which the color layer is formed is smaller than a width d1 of a mask 1b (2b) at a boundary portion with a laterally adjacent pixel. The reason is that, the internal mask 1c (2c) is not spliced to the black matrix of other pixel. Since the mask 1b (2b) at the boundary portion with an adjacent pixel is connected (spliced) to the black matrix of the adjacent pixel, this mask is thickened in order to form a mosaic pattern. When the width d1 of the mask 1b (2b) at the boundary portion with the laterally adjacent pixel is set to be 24 μm, for example, the width d2 of the mask 1c (2c) at the boundary portion of the window parts 1a (2a) is set to be 12 μm. A width d3 of a mask 1d (2d) at a boundary portion with a longitudinally adjacent pixel is set to be 50 to 60 μm.

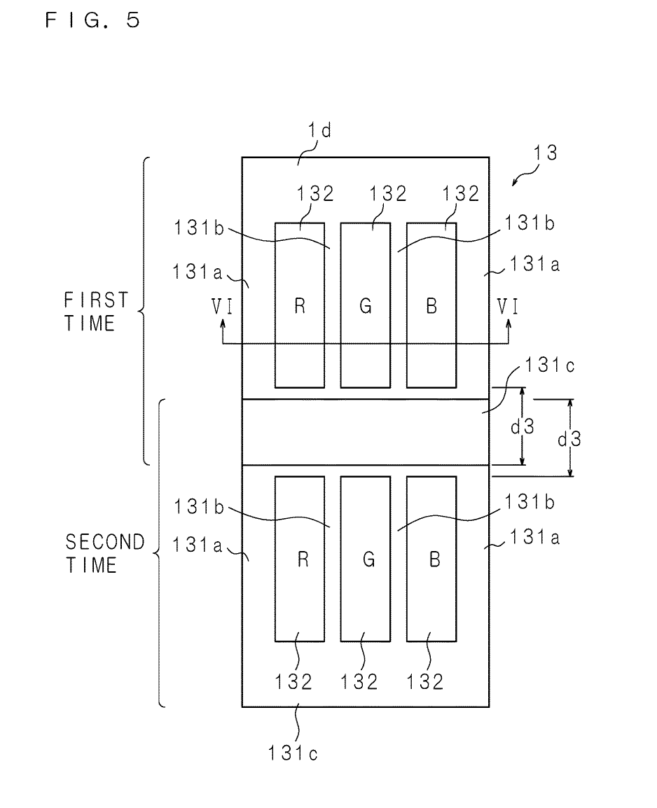

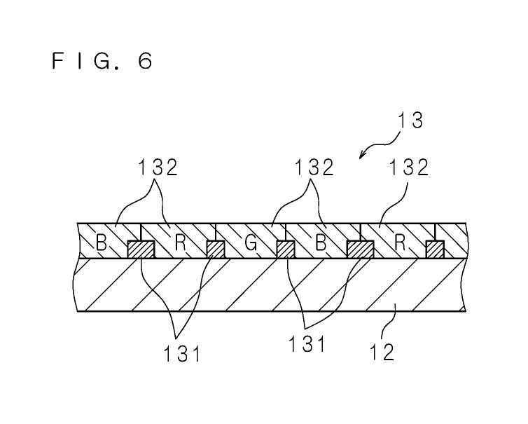

FIGS. 5 and 6 are explanatory views illustrating an example of the color filter layer 13. FIG. 5 is a plan view of the color filter layer 13, and FIG. 6 is a cross-sectional view taken on line V-V in FIG. 5A. The color filter layer 13 illustrated in FIG. 5 shows a range formed by the two mask patterns illustrated in FIG. 4. A black matrix 131 for one pixel illustrated on the upper side of FIG. 5 is a matrix formed by the first mask pattern 1. A black matrix 131 for one pixel illustrated on the lower side thereof is a matrix formed by the second mask pattern 2. A width of a portion 131a spliced to the laterally adjacent black matrix is larger than that of a portion 131b located between color filters 132. Moreover, a width of a portion 131c spliced to the longitudinally adjacent black matrix is smaller than the width d3 of the mask 1d (2d) at the boundary portion with the longitudinally adjacent pixel. Be noted that R, G and B described in the color filters 132 indicate a red color (RED), a green color (GREEN), and a blue color (BLUE), respectively.

The mosaic pattern used for mosaic splicing in Embodiment 1 will be described. Hereinafter, a black matrix in Ultra High Definition (UHD) is applied to Embodiment 1. An object to be compared is a black matrix with Full High Definition (FHD) resolution formed by the conventional art. Similar to the conventional art, also in Embodiment 1, the mosaic pattern used for mosaic splicing includes a plurality of dots. In Embodiment 1, a longitudinal width of the dots constituting the mosaic pattern is 1/2 as compared to the conventional art. In addition, a lateral width of the dots is 3/2 as compared to the conventional art. Thereby, a size (area) of the dots is 3/4 of the conventional dot. As such, even when the mosaic splicing is performed for each one pixel formed by combining a plurality of picture elements in QFHD, the size of the mosaic is smaller than that of the conventional mosaic, and the fineness is therefore improved as compared to the conventional FHD.

As described above, in Embodiment 1, the black matrix for one pixel is formed by one exposure. Therefore, there is no mosaic splicing of the black matrix within one pixel. Accordingly, a positional shift causing a void does not occur, such that it is possible to decrease a width of the black matrix. Thereby, it is possible to secure a sufficient aperture ratio.

In addition, since the size of the dots constituting the mosaic pattern is decreased, it is possible to improve the fineness of the liquid crystal display panel.

### Modified Example

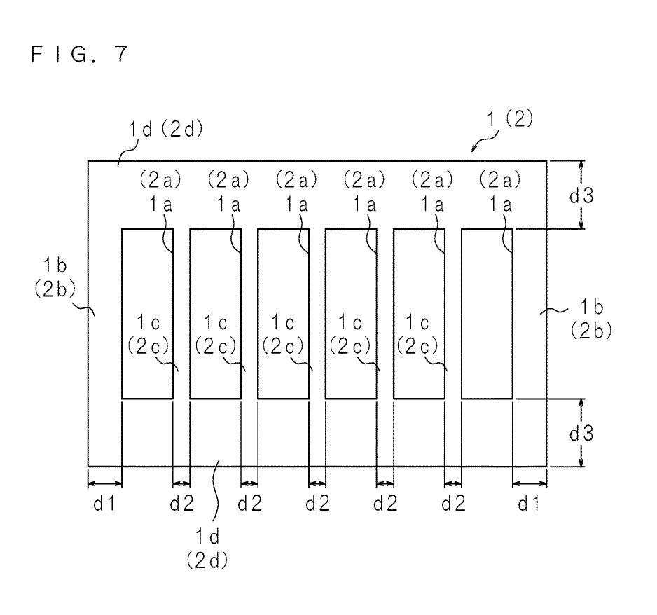

FIG. 7 is an explanatory view illustrating an example of the mask pattern of the photo mask. The mask pattern in the modified example is a mask pattern allowing exposure of a black matrix for two adjacent pixels. By a first mask pattern 1 and a second mask pattern 2, exposure of a black matrix for a total of four pixels is performed. In the first mask pattern 1 illustrated in FIG. 7, the number of the window parts 1a is different from that in FIG. 1, and the other portions are the same as those in FIG. 1, therefore the same parts will be denoted by the same reference numerals, and will not be described. Also, the second mask pattern 2 is the same as the first mask pattern 1, therefore portions corresponding to the first mask pattern will be denoted by corresponding reference numerals.

In the modified example, the exposure of the black matrix for two pixels is performed with one mask pattern, and it is therefore possible to complement the width of the black matrix between two pixels adjacent to each other formed by simultaneously exposing, and secure a sufficient aperture ratio.

In the modified example, the black matrix for two pixels is simultaneously exposed, but it is not limited thereto, and a black matrix for three pixels or more may be simultaneously exposed. In a case of higher definition such as 8K4K resolution, the number of pixels to be simultaneously exposed is increased, and it is therefore possible to improve the fineness of the liquid crystal display panel.

### Embodiment 2

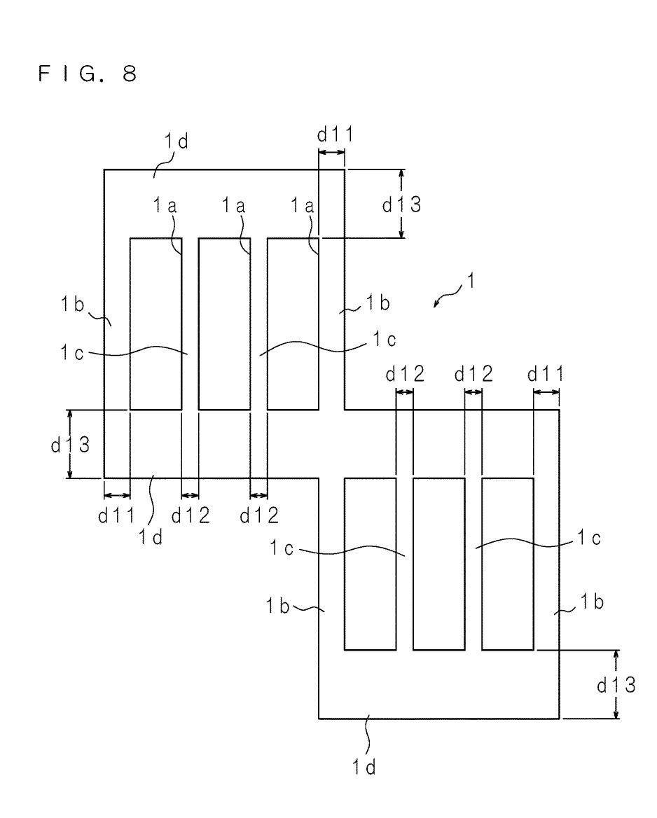

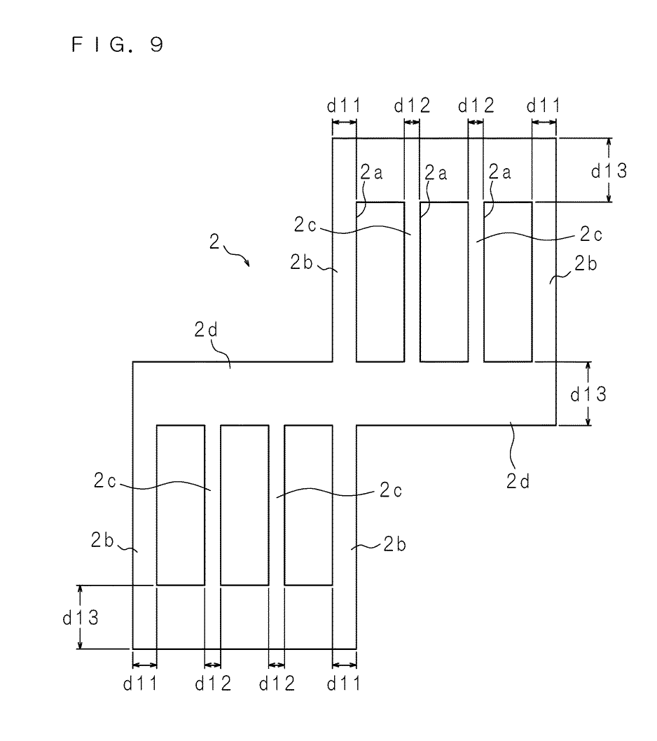

Embodiment 2 is an embodiment about a mask pattern allowing exposure of a black matrix for two pixels with each mask pattern and for four pixels with two mask patterns, respectively. FIGS. 8 and 9 are explanatory views illustrating an example of the mask pattern of the photo mask. A first mask pattern 1 and a second mask pattern 2 have the same configuration as each other, and are formed in a shape in which two mask patterns for one pixel are arranged in a checkered pattern (at diagonal positions) and are connected at a corner portion, respectively. The mask pattern for one pixel is the same as that in Embodiment 1, and therefore, in the following description, portions different from those in Embodiment 1 will be mainly described. In Embodiment 2, a width d12 of a mask 1c (2c) at a boundary portion of the window parts 1a (2a) is smaller than a width d11 of the mask 1b (2b) at a boundary portion with the laterally adjacent pixel, similar to Embodiment 1. For example, when the width d11 of the mask 1b (2b) at the boundary portion with the laterally adjacent pixel is set to be 18 μm, the width d12 of the mask 1c (2c) at the boundary portion of the window parts 1a (2a) is set to be 12 μm. A width d13 of a mask 1d (2d) at a boundary portion with the longitudinally adjacent pixel is set to be 50 to 60 μm.

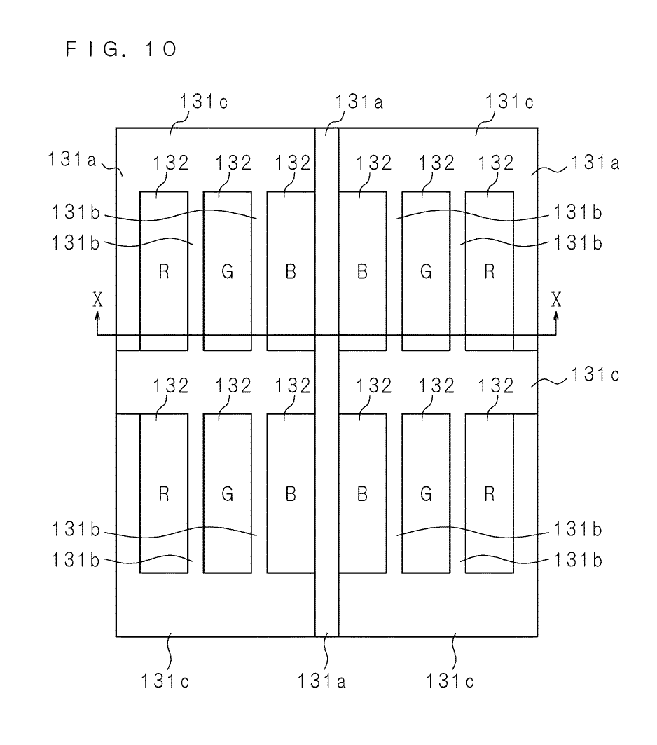

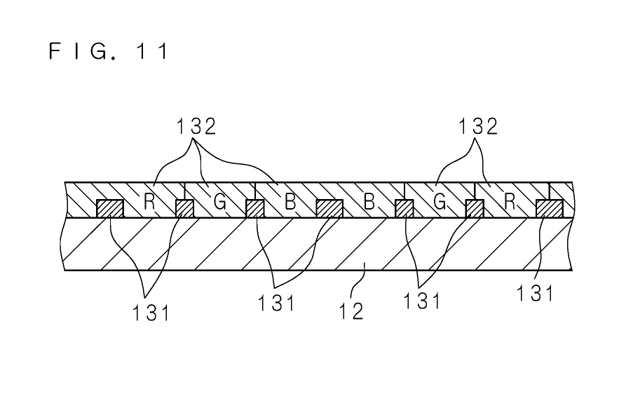

FIGS. 10 and 11 are explanatory views illustrating an example of a color filter layer 13. FIG. 10 is a plan view of the color filter layer 13, and FIG. 11 is a cross-sectional view taken on line X-X in FIG. 10. The color filter layer 13 illustrated in FIG. 10 shows a range formed by the two mask patterns illustrated in FIGS. 8 and 9. A black matrix 131 for two pixels illustrated on the upper left side and the lower right side in FIG. 10 is formed by the first mask pattern 1. A black matrix 131 for two pixels illustrated on the upper right side and the lower left side thereof is formed by the second mask pattern 2. A width of a portion 131a splicing the laterally adjacent black matrix is larger than that of a portion 131b located between color filters 132. As illustrated in FIG. 10, colors of picture elements of pixels adjacent to each other in the lateral direction are the same as each other.

As described above, in Embodiment 2, in addition to the effects produced in Embodiment 1, the following effects are produced. Since the colors of the adjacent picture elements of the pixels adjacent to each other in the lateral direction are the same as each other, it is not necessary to increase the width of the black matrix in order to cope with the positional shift in a coloring process of the picture element. Therefore, it is possible to further decrease the width (d11) of the black matrix of pixels adjacent to each other in the lateral direction with respect to the width (d1) in Embodiment 1, and to increase the aperture ratio.

### Embodiment 3

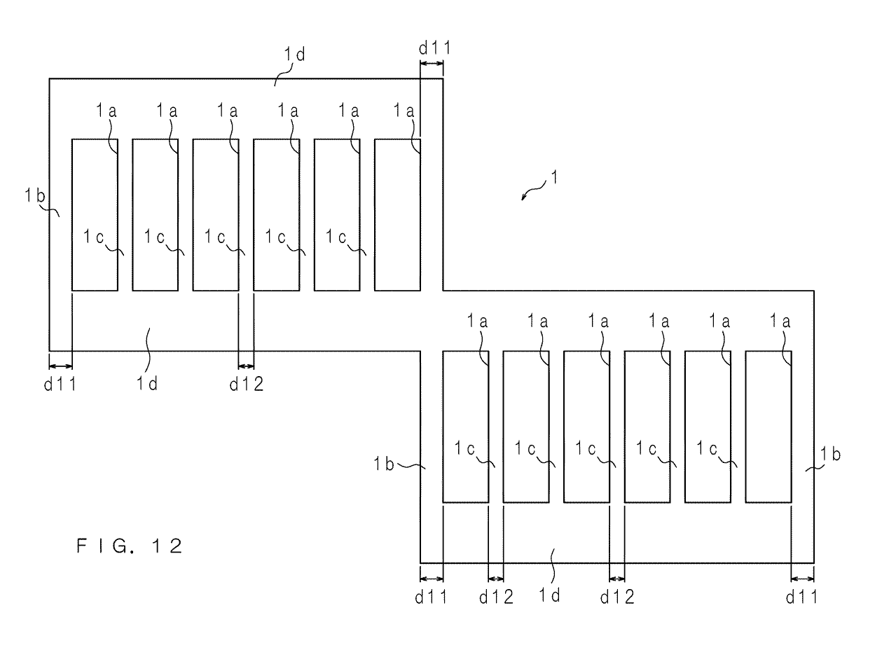

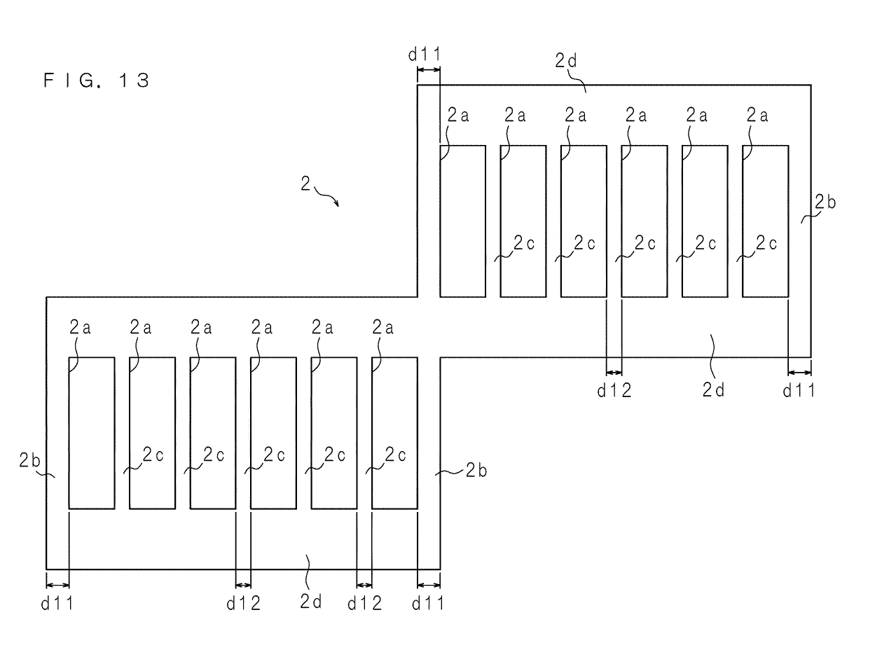

In Embodiment 3, a black matrix for two pixels adjacent to each other in the lateral direction (a direction along a short side of the picture element) is formed. FIGS. 12 and 13 are explanatory views illustrating an example of the mask pattern of the photo mask. FIG. 12 illustrates a first mask pattern 1 of the photo mask, and FIG. 13 illustrates a second mask pattern 2 of the photo mask. In the mask patterns illustrated in FIG. 12 and FIG. 13, two patterns are arranged in a checkered pattern, similar to FIGS. 8 and 9. The respective patterns allow forming of a black matrix for two pixels adjacent to each other in the lateral direction. Each of the first mask pattern 1 and the second mask pattern 2 allows exposure of a black matrix for four pixels in one exposure process.

In Embodiment 3, since the black matrix for two pixels adjacent to each other in the lateral direction is simultaneously formed, there is no need to splice the black matrix between the adjacent pixels. Therefore, as illustrated in FIGS. 12 and 13, the width of the black matrix between the adjacent pixels may also be set to be d12. As a result, it is possible to improve the aperture ratio.

Be noted that the black matrix extending laterally needs to have a width within a certain degree. A domain in the vicinity of a bus line on a thin film transistor (TFT) side formed in the transparent substrate 19 becomes a liquid crystal misaligned place. If there is the liquid crystal misaligned place, the domain will not turn black even when displaying black, such that a decrease in a contrast occurs. In order to shield the liquid crystal misaligned place, it is necessary to secure the width of the black matrix within a certain degree.

Further, in the above-described embodiments, a method of bonding a color filter (CF) substrate and a TFT substrate as a configuration of the liquid crystal display panel is assumed, but it is not limited thereto. It is also possible to apply to a liquid crystal display panel having a CF on array (COA) structure in which the colored layer is formed on the TFT substrate side.

In Embodiments 1 to 3, the mask pattern that can form the black matrix in one pixel (three picture elements) unit is employed, but it is not limited thereto. A mask pattern that can form two or four or more adjacent picture elements as one unit may be employed. In that case, it is possible to decrease the width of the black matrix between a plurality of picture elements constituting one unit.

Be noted that, in FIGS. 1, 6 and 11, a film thickness of the black matrix 131 (a vertical dimension in the paper) is uniformly illustrated. To be precise, the splicing part, that is, a portion which is doubly exposed with the first mask pattern 1 and the second mask pattern 2 has a slightly larger film thickness than the other portions.

Technical characteristics (configuration requirements) described in each embodiment may be combined with each other, and new technical characteristics may be formed by combining the same. It should be understood that the embodiments disclosed herein are illustrative and non-restrictive in every respect. Since the scope of the present invention is defined by the appended claims rather than by the description preceding them, and all changes that fall within metes and bounds of the claims, or equivalence of such metes and bounds thereof are therefore intended to be embraced by the claims.

It is noted that, as used herein and in the appended claims, the singular forms “a”, “an”, and “the” include plural referents unless the context clearly dictates otherwise.

1-6. (canceled)

7. A liquid crystal display panel comprising two opposing substrates provided with liquid crystal sealed therebetween,
wherein on one substrate a plurality of colored parts are arranged so as to constitute one pixel, and a plurality of boundary regions are arranged between a plurality of adjacent colored parts and around the plurality of colored parts, and
wherein the boundary region arranged between adjacent colored parts has a width smaller than that of the boundary region arranged around the plurality of colored parts.

8. The liquid crystal display panel according to claim 7,
wherein a plurality of the boundary regions arranged around the plurality of colored parts are arranged at a constant interval.

9. The liquid crystal display panel according to claim 8,
wherein the plurality of the boundary regions arranged around the plurality of colored parts are arranged between adjacent pixels.

10. A liquid crystal display apparatus comprising a liquid crystal display panel according to claim 7 as a display section.

11. A method of manufacturing a liquid crystal display panel, comprising:
preparing a photo mask provided with linear patterns at positions corresponding to boundary regions between a plurality of adjacent colored parts and around the plurality of colored parts, the liner pattern in a portion corresponding to the boundary region between adjacent colored parts having a width smaller than that of the liner pattern in a portion corresponding to the boundary region around the plurality of colored parts;
sequentially performing exposure on one substrate by photolithography using the photo mask so that the colored parts are arranged in a matrix to form lattice-shaped boundary regions;
adding colors inside lattices formed by the boundary regions to form a plurality of colored parts so as to constitute respective pixels each including a plurality of colored parts; and
opposing the one substrate and the other substrate, and then sealing liquid crystal therebetween.

12. A method of manufacturing a liquid crystal display panel, comprising:
preparing a photo mask provided with linear patterns at positions corresponding to boundary regions between a plurality of adjacent colored parts and around the plurality of colored parts, the liner pattern in a portion corresponding to the boundary region between adjacent colored parts having a width smaller than that of the liner pattern in a portion corresponding to the boundary region around the plurality of colored parts, the photo mask being capable of simultaneously forming boundary regions corresponding to a plurality of pixels each including a plurality of colored parts;
sequentially performing exposure on one substrate by photolithography using the photo mask so that the pixels are arranged in a matrix to form lattice-shaped boundary regions;
adding colors inside lattices formed by the boundary regions to form a plurality of colored parts so as to constitute respective pixels; and
opposing the one substrate and the other substrate, and then sealing liquid crystal therebetween.
